(19) United States
(12) Patent Application Publication
(10) Pub. No.: US 2023/0278704 A1
(43) Pub. Date: Sep. 7, 2023

(54) AIR VEHICLES INCLUDING FREEWINGS AND RELATED METHODS

(71) Applicant: Aurora Flight Sciences Corporation, a subsidiary of the Boeing Company, Manassas, VA (US)

(72) Inventor: Gilbert Lewis Crouse, JR., Manassas, VA (US)

(21) Appl. No.: 17/687,366

(22) Filed: Mar. 4, 2022

(51) Int. Cl. B64C 29/00; B64C 27/58; B64C 3/38; B64C 27/08; B64C 9/04; B64C 13/24

(52) U.S. Cl. CPC B64C 29/0033; B64C 27/58; B64C 3/38; B64C 27/08; B64C 9/04; B64C 13/24

(57) ABSTRACT

Example air vehicles including freewings and related methods are disclosed herein. An example air vehicle includes a fuselage; a freewing coupled to the fuselage, the freewing pivotable relative to the fuselage; and a rotor carried by the freewing, the rotor pivotable independently of the freewing.

### FIELD OF THE DISCLOSURE

This disclosure relates generally to air vehicles and, more particularly, to air vehicles including freewings and related methods.

### BACKGROUND

A vertical takeoff and landing vehicle can take off and land vertically. Such vehicles can also operate in a hover mode.

### SUMMARY

An example air vehicle includes a fuselage; a freewing coupled to the fuselage, the freewing pivotable relative to the fuselage; and a rotor carried by the freewing, the rotor pivotable independently of the freewing.

Another example air vehicle includes a fuselage; a first freewing pivotably coupled to the fuselage; a second freewing pivotably coupled to the fuselage and spaced apart from the first freewing; a first rotor; and an actuator to cause the first rotor to tilt to change an orientation of the first rotor relative to the fuselage during flight.

An example method includes causing a first rotor coupled to a first freewing of an aircraft to operate in a first orientation relative to a fuselage of the aircraft, the aircraft to operate in a hover mode when the first rotor is in the first orientation; and causing the first rotor to move from the first orientation to a second orientation relative to the fuselage during flight of the aircraft, the aircraft to operate in a forward flight mode when the first rotor is in the second orientation.

### BRIEF DESCRIPTION OF THE DRAWINGS

FIG. 1 is a top view of a first example air vehicle in accordance with teachings of this disclosure, the first example air vehicle shown in a first flight mode in FIG. 1 and including one or more freewings and control system circuitry.

FIG. 2 is a side view of the first example air vehicle of FIG. 1 in the first flight mode.

FIG. 3 is a top view of the first example air vehicle of FIG. 1 in a second flight mode.

FIG. 4 is a side view of the first example air vehicle of FIG. 1 in the second flight mode.

FIG. 5 is a cross-sectional view of a freewing of the first example air vehicle of FIG. 1 taken along line 5-5 of FIG. 3.

FIG. 6 illustrates an example control surface of the example freewing of FIG. 5.

FIG. 7 is a top view of a second example air vehicle in accordance with teachings of this disclosure, the second example air vehicle shown in the first flight mode in FIG. 7 and including one or more freewings and control system circuitry.

FIG. 8 is a side view of the second example air vehicle of FIG. 7 in the first flight mode.

FIG. 9 is a top view of the second example air vehicle of FIG. 7 in the second flight mode.

FIG. 10 is a side view of the second example air vehicle of FIG. 7 in the second flight mode.

FIG. 11 is a top view of a third example air vehicle in accordance with teachings of this disclosure, the third example air vehicle shown in the first flight mode in FIG. 11 and including one or more freewings and control system circuitry.

FIG. 12 is a side view of the third example air vehicle of FIG. 11 in the first flight mode.

FIG. 13 is a top view of the third example air vehicle of FIG. 11 in the second flight mode.

FIG. 14 is a side view of the third example air vehicle of FIG. 11 in the second flight mode.

FIG. 15 is a top view of a fourth example air vehicle including one or more stabilizers in accordance with teachings of this disclosure.

FIG. 16 is a side view of the fourth example air vehicle of FIG. 15.

FIG. 17 is a flowchart representative of example machine readable instructions and/or example operations that may be executed by example processor circuitry to implement the control system circuitry of FIGS. 1, 7, and/or 11 in accordance with teachings of this disclosure.

FIG. 18 is a block diagram of an example processing platform including processor circuitry structured to execute the example machine readable instructions and/or the example operations of FIG. 17 to implement the control system circuitry of FIGS. 1, 7, and/or 11.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily imply that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

A vertical takeoff and landing vehicle can take off and land vertically and can operate in both a forward flight and a hover mode. For instance, a multicopter such as a quadcopter includes rotors to facilitate vertical take-off, landing, and hovering of the aircraft. In some examples, a vertical takeoff and landing vehicle device includes fixed wings to facilitate forward flight of the vehicle by providing lift, thereby increasing a flight range of the air vehicle.

Disclosed herein are example vertical takeoff and landing vehicles including freewings and rotor(s) to enable the air vehicle to transition between vertical flight, hovering, and forward flight modes. In examples disclosed herein, the freewing is pivotably coupled to a fuselage of the air vehicle. During flight, the freewing pivots such that an angle of incidence of the freewing (i.e., an angle between a longitudinal axis of the fuselage and a chord line of the freewing) changes during flight. In particular, the angle of incidence of the freewing changes to maintain an angle of attack (i.e., an angle between a chord line of the wing and a flight path vector) such that the combined aerodynamic and inertial moment about the pivot point of the freewing is zero. The angle of attack can be defined based on, for instance, deflection of a flap of the trailing edge of the freewing from a neutral or retracted position to a raised or lowered position. The freewing automatically pivots during flight to maintain the angle of attack and to prevent stalling of the freewing.

Some example air vehicles disclosed herein include rotors supported by (e.g., carried by) the freewings. In some examples disclosed herein, the rotors are actuated to pivot (e.g., tilt) between a first rotor orientation in which the rotors rotate in a substantially horizontal plane of rotation to generate thrust and lift to facilitate vertical flight and/or hovering of the air vehicle and a second rotor orientation in which the rotors rotate in a substantially vertical plane of rotation to generate thrust during forward flight, where lift is provided by the freewings.

Example air vehicles disclosed herein provide for efficient transition between a vertical flight mode and a forward flight mode. The freewings automatically pivot during flight and, thus, reduce or eliminate activity of the control system(s) of the example air vehicles with respect to controlling the angle of incidence of the wings. The automatic pivoting of the freewings also provides for efficient and more predictable generation of lift as compared to if the orientation of the wings were controlled based on, for example, user inputs. In disclosed examples, the lift generated by the freewings can be refined by controlling deflection of the control surface(s) (e.g., flap(s)) of the freewings. In examples disclosed herein, the freewings can pivot such that a leading edge of the freewings rotate upward (e.g., toward the rotors) during operation of the air vehicle in the hover mode as a result of airflow generated by the rotors. The pivoting of the freewings during hover mode reduces downward forces exerted on the freewings due to operation of the rotors as compared to vehicles with fixed wings and, thus, provides for more efficient operation of the disclosed air vehicle in the hover mode. The automatic pivoting of the freewings during the transition of the air vehicle from vertical flight (e.g., the hover mode) to forward flight to generate lift increases a stability of the transition between flight modes.

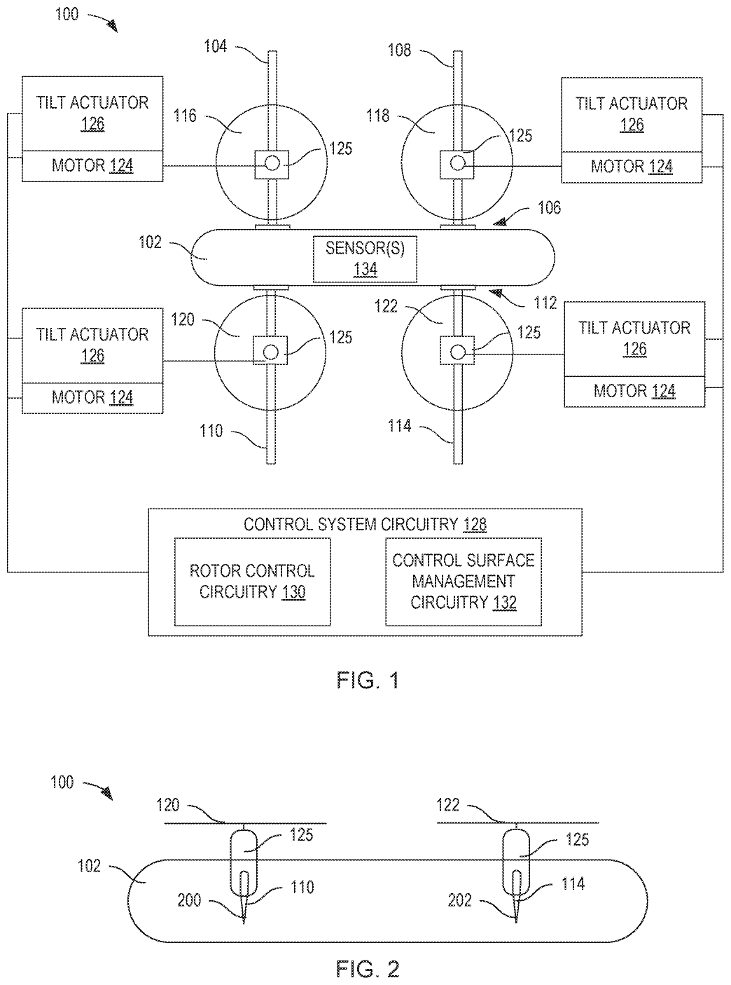

FIG. 1 illustrates a first example air vehicle 100 in accordance with teachings of this disclosure. In particular, FIG. 1 illustrates a top view of the air vehicle 100 when the air vehicle 100 is operating in a first flight mode. In the example of FIG. 1, the first flight mode is a hover mode. Alternatively, FIG. 1 may illustrate the air vehicle 100 in vertical takeoff stage of flight or vertical landing flight stage.

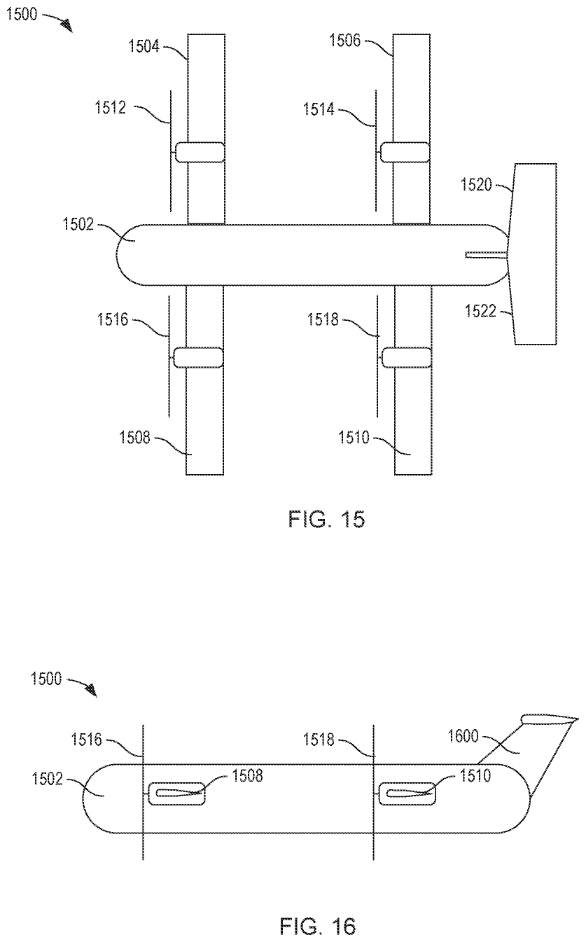

The example air vehicle 100 of FIG. 1 includes a fuselage 102. The air vehicle 100 includes a first freewing 104 pivotably coupled to a first side 106 of the fuselage 102 and a second freewing 108 pivotably coupled to the first side 106 of the fuselage 102. The air vehicle 100 includes a third freewing 110 pivotably coupled to a second side 112 of the fuselage 102 opposite the first side 106 and a fourth freewing 114 pivotably coupled to the second side 112 of the fuselage 102. In the example of FIG. 1, the first and third freewings 104, 110 are pivotably coupled to a forward section of the fuselage 102 and the second and fourth freewings 108, 114 are pivotably coupled to an aft section of the fuselage 102. However, the freewings 104, 108, 110, 114 can be coupled to the fuselage 102 in a different arrangement than shown in FIG. 1 and/or can have different shapes and/or sizes than shown in FIG. 1. The example air vehicle 100 can include additional or fewer freewings than shown in FIG. 1. Also, as disclosed herein, in some examples, the air vehicle 100 includes horizontal and/or vertical stabilizers (FIGS. 15 and 16). The air vehicle 100 can include other components than those illustrated in FIG. 1, such as landing gear.

In the example of FIG. 1, a first rotor 116 (e.g., a proprotor) is carried by, supported by, or otherwise coupled to the first freewing 104. The first rotor 116 can be carried by the first freewing 104 via a mount 125 coupled to the first freewing 104. In the examples disclosed herein, although the rotor 116 and the mount 125 are carried by the first freewing 104, the rotor 116 and the mount 125 do not tilt with the freewing 104. Rather, the rotor 116 and the mount 125 tilt independently of the freewing 104, as disclosed herein. The first rotor 116 can include, for instance, two or more blades that rotate about a shaft operatively coupled to a first motor 124. In the example of FIG. 1, the first motor 124 controls operation of the first rotor 116 (e.g., a speed at which the blades of the first rotor 116 rotate). Also, in the example of FIG. 1, the first rotor 116 is operatively coupled to a first tilt actuator 126. In some examples, one or more of the first motor 124 or the tilt actuator 126 are carried by the first freewing 104 via the mount 125 that supports the first rotor 116.

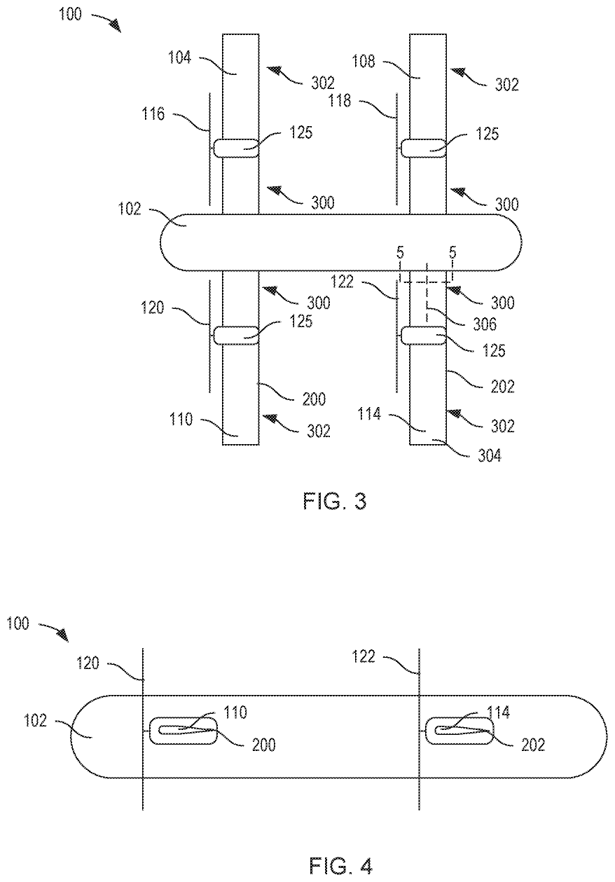

The tilt actuator 126 provides means for causing the first rotor 116 to tilt or pivot relative to the fuselage 102. As disclosed herein, the tilt actuator 126 causes the first rotor 116 to move between (a) a first rotor orientation as shown in FIG. 1, in which the first rotor 116 rotates in a substantially horizontal plane of rotation to produce thrust and lift for vertical takeoff, hovering, and vertical landing of the air vehicle 100 and (b) a second rotor orientation (FIG. 3) in which the first rotor 116 rotates in a substantially vertical plane of rotation to produce thrust during forward flight of the air vehicle 100 (in such examples, lift is provided by the freewings 104, 108, 110, 114). The tilt actuator 126 can include, for example a hydraulic or electric actuator that can cause a shaft of the first rotor 116 to tilt. Thus, in the example if FIG. 1, the first rotor 116 can pivot independently of pivoting of the first freewing 104.

In the example of FIG. 1, the motor 124 and the tilt actuator 126 are communicatively coupled to control system circuitry 128 of the air vehicle 100. The control system circuitry 128 of FIG. 1 includes rotor control circuitry 130 to generate and output instructions to control operation of the motor 124 and, thus, the first rotor 116 (e.g., speed of rotation). Additionally, the rotor control circuitry 130 can generate instructions to control operation of the tilt actuator 126. In response to the instructions from the rotor control circuitry 130, the tilt actuator 126 causes the first rotor 116 to tilt between the first and second rotor orientations based on, for instance, a flight mode of the air vehicle 100 (e.g., a hover mode, a forward flight mode).

Also, the air vehicle 100 includes sensor(s) 134, such as inertial sensor(s) to measure vehicle attitude and acceleration, air data sensor(s) to measure airspeed and altitude, and satellite navigation sensor(s) such as global positing system (GPS) sensor(s). The sensor(s) 134 output signal(s) that are used by the control system circuitry 128 to control the air vehicle 100 in flight.

The example air vehicle 100 of FIG. 1 includes a second rotor 118 carried by the second freewing 108, a third rotor 120 carried by the third freewing 110, and a fourth rotor 122 carried by the fourth freewing 114. Thus, the example air vehicle 100 of FIG. 1 is a tandem wing quadcopter. The air vehicle 100 can include additional rotors (e.g., six rotors, eight rotors).

The second, third, and fourth rotors 118, 120, 122 can be substantially the same as the first rotor 116 (e.g., including two or more blades that rotate about a shaft of the respective rotor). Each of the rotors 118, 120, 122 is coupled to the corresponding freewing 108, 110, 114 via a respective mount 125 as disclosed in connection with the first rotor 116. Also, each of the rotors 118, 120, 122 is in communication with a respective motor 124 and actuator 126. The motors 124 and the tilt actuator 126 are communicatively coupled to the rotor control circuitry 130, which generates instructions to, for instance, control operation of the respective motors 124, cause the respective tilt actuators 126 to cause the corresponding rotors 118, 120, 122 to pivot, etc.

The freewings 104, 108, 110, 114 can include one or more aft control surfaces, such as flap(s) (FIG. 6). The example control system circuitry 128 of FIG. 1 includes control surface management circuitry 132. The control surface management circuitry 132 generates instructions to control actuation of the control surface(s) via control surface actuator(s) (FIG. 6) associated with each freewing 104, 108, 110, 114. As disclosed herein, the actuation of the control surface(s) can affect an angle of attack of the freewings 104, 108, 110, 114 and, thus, affect pivoting of the freewings 104, 108, 110, 114 relative to the fuselage 102 during flight.

FIG. 2 is a side view of the example air vehicle 100 of FIG. 1 in the hover mode. When the air vehicle 100 is in the hover mode, the rotors 116, 118, 120, 122 are in the first rotor orientation shown in FIGS. 1 and 2. Airflow generated by the rotation of the rotors 116, 118, 120, 122 flows downward to provide lift for vertical takeoff, hovering, and/or landing. The airflow generated by the rotors 116, 118, 120, 122 exerts a downward force, or download, on the corresponding freewings 104, 108, 110, 114. In particular, the airflow causes the freewings 104, 108, 110, 114 to rotate or pivot relative to the fuselage 102 such that a trailing edge of each freewing 104, 108, 110, 114 is oriented in a downward direction (e.g., toward a ground surface) as a result of the rotation of the corresponding freewings 104, 108, 110, 114.

For example, as shown in FIG. 2, the third freewing 110 is rotated relative to the fuselage 102 such that a trailing edge 200 of the third freewing 110 is substantially directed toward the ground surface. As shown in FIG. 2, the third rotor 120 is disposed opposite or substantially opposite the trailing edge 200 of the third freewing 110 when the third rotor 120 is in the first rotor orientation. Similarly, the fourth freewing 114 is rotated relative to the fuselage 102 such that a trailing edge 202 of the fourth freewing 114 is substantially directed toward the ground surface. As a result of the rotation of the freewings 104, 108, 110, 114 as shown in FIG. 2, downward forces on the freewings 104, 108, 110, 114 are reduced, which provides for more efficient operation of the air vehicle 100 in the hover mode.

FIG. 3 is a top view of the example air vehicle 100 of FIG. 1 in a second flight mode. FIG. 4 is a side view of the example air vehicle 100 in the second flight mode. In the examples of FIGS. 3 and 4, the second flight mode is a forward flight mode, or a mode in which the freewings 104, 108, 110, 114 produce lift during forward flight of the air vehicle 100.

The air vehicle 100 can transition from vertical flight or hovering to forward flight in response to, for instance, a command generated by the control system circuitry 128. In the example of FIG. 3, the tilt actuators 126 associated with each rotor 116, 118, 120, 122 cause the rotors 116, 118, 120, 122 to tilt (e.g., in response to instructions from the rotor control circuitry 130 of FIG. 1). In particular, the tilt actuators cause 126 cause the corresponding rotors 116, 118, 120, 122 to move from the first rotor orientation shown in FIGS. 1 and 2 in which each of the rotors 116, 118, 120, 122 rotates in a substantially horizontal plane of rotation to the second rotor orientation shown in FIGS. 3 and 4 in which each of the rotors 116, 118, 120, 122 rotates in a substantially vertical plane of rotation. The transition of the rotors 116, 118, 120, 122 from the first rotor orientation to the second rotor orientation facilities the transition of the air vehicle 100 from the vertical takeoff mode or hover mode shown in FIG. 1 to the forward flight mode of FIGS. 3 and 4. When the air vehicle 100 is in the forward flight mode, the rotors 116, 118, 120, 122 produce thrust and the freewings 104, 108, 110, 114 produce lift to maintain flight. Thus, in the forward flight mode, the freewings 104, 108, 110, 114 offload the generation of lift from the rotors to increase a range and/or endurance of the air vehicle 100 in forward flight. During forward flight, the rotor control circuitry 130 (FIG. 1) can generate instructions to adjust thrust generated by the rotors 116, 118, 120, 122 to control attitude and direction of the air vehicle 100.

When the rotors 116, 118, 120, 122 are moved to the second rotor orientation, air flow causes the freewings 104, 108, 110, 114 to rotate to substantially align with a direction of airflow over the freewings 104, 108, 110, 114 (e.g., align with freestream velocity). As shown in FIG. 4, when the air vehicle 100 transitions from the hover mode to the forward flight mode, the third freewing 110 pivots such that the trailing edge 200 of the third freewing 110 moves counterclockwise relative to the position of the third freewing 110 in FIG. 2 such that the third freewing 110 is substantially aligned with the freestream or airflow over the third freewing 110. Similarly, the fourth freewing 114 pivots such that the trailing edge 202 of the fourth freewing 114 moves counterclockwise relative to the position of the fourth freewing 114 in FIG. 2 such that the fourth freewing 114 is substantially aligned with the freestream or airflow over the fourth freewing 114.

As disclosed herein, the freewings 104, 108, 110, 114 automatically pivot relative to the fuselage 102 during flight to maintain the angle of attack. Referring again to FIG. 3, each of the freewings 104, 108, 110, 114 can include an inboard section 300 extending between the fuselage 102 and the rotor mount 125 and an outboard section 302 extending between the rotor mount 125 and a wingtip 304 of the respective freewings 104, 108, 110, 114. The freewings 104, 108, 110, 114 can include more than two sections.

The freewings 104, 108, 110, 114 of FIGS. 1-4 pivot about a spar coupled to the fuselage 102. For instance, a spar 306 about which the fourth freewing 114 pivots is represented in FIG. 3 by a dashed line. In some examples, the spar 306 extends substantially along a length of the fourth freewing 114. In the example of FIG. 3, the spar 306 extends along the inboard section 300 of the freewing 114. In such examples, the outboard section 302 of the fourth freewing 114 can be pivotably coupled to the inboard section 300 of the fourth freewing 114 via a separate joint (e.g., a rotational bearing) such that the inboard and outboard sections 300, 302 of the fourth freewing 114 are pivotable relative to the fuselage 102.

In other examples, the spar 306 extends substantially along a length of the fourth freewing 114 from a location at which the spar 306 couples to the fuselage 102 to the wingtip 304 of the freewing 114. In such examples, both the inboard section 300 and the outboard section 302 of the fourth freewing 114 pivot about the spar 306 in unison or substantially in unison. The first, second, and third freewings 104, 108, 110 can rotate about respective spars 306 as disclosed in connection with the fourth freewing 114.

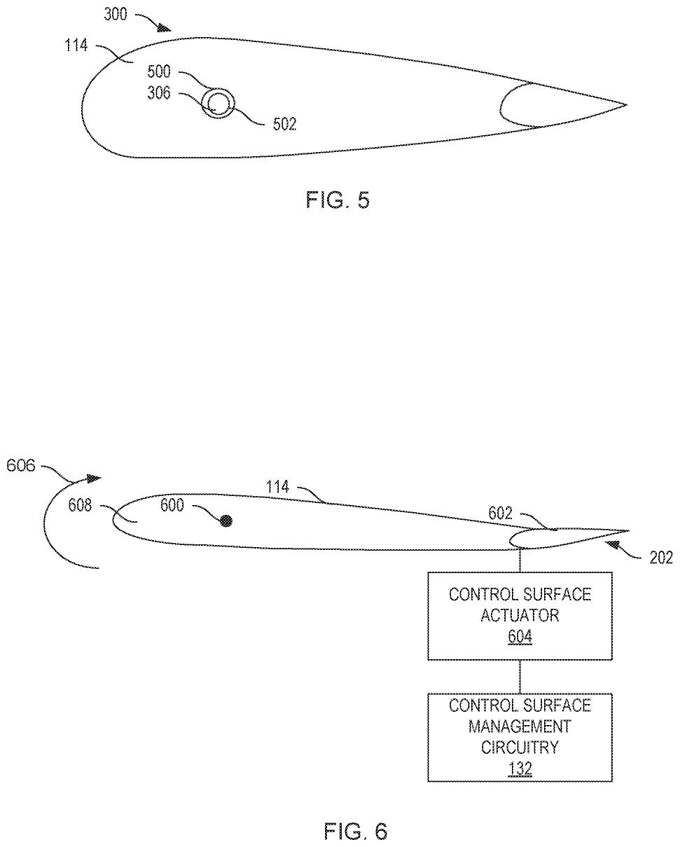

FIG. 5 is a cross-sectional view of the fourth freewing 114 of the example air vehicle 100 of FIGS. 1-4 take along line 5-5 of FIG. 3. Although FIG. 5 is discussed in connection with the fourth freewing 114, the first, second, and/or third freewings 104, 108, 110, 114 of the air vehicle 100 of FIGS. 1-4 can be the same or substantially the same as the fourth freewing 114 shown in FIG. 5.

The cross-sectional view of FIG. 5 illustrates the inboard section 300 of the fourth freewing 114 extending between the fuselage 102 and the rotor mount 125 as shown in FIG. 3. As disclosed in connection with FIG. 3, the fourth freewing 114 is pivotably coupled to the fuselage 102 (FIGS. 1, 3) of the air vehicle 100 via the spar 306 (e.g., a non-rotating spar). As shown in FIG. 5, the spar 306 extends through a sleeve 500, where the sleeve 500 is disposed in an aperture defined in the fourth freewing 114. A bearing material 502 can be disposed between the spar 306 and the sleeve 500 to facilitate rotation of the fourth freewing 114 about the spar 306.

The spar 306 defines a pivot point about which at least a portion of the fourth freewing 114 (e.g., the inboard section 300) rotates. A position of the spar 306 relative to the fourth freewing 114 and, thus, the location of the pivot point can be selected to enable the fourth freewing 114 to obtain aerodynamic stability based on a selected angle of attack, as discussed in connection with FIG. 6.

The fourth freewing 114 includes the inboard section 300 and the outboard section 302 (FIG. 3) due to, for instance, the coupling of the fourth rotor 122 to the fourth freewing 114. However, the sections 300, 302 of the fourth freewing 114 can introduce lateral instabilities during flight if each of the sections 300, 302 pivots independently. To prevent such lateral instabilities, in some examples, the spar 306 extends substantially along a length of the fourth freewing 114 such that the outboard section 302 of fourth freewing 114 rotates about the spar 306 (e.g., via the sleeve 500). In such examples, the sections 300, 302 of the fourth freewing 114 rotate in unison or substantially in unison during pivoting of the fourth freewing 114. In other examples, a separate rotational bearing is provided between the inboard section 300 and the outboard section 302 to cause the outboard section 302 to pivot with the inboard section 300. In other examples, the air vehicle 100 can include sensors to detect changes in, for instance, roll rates of the fuselage 102. In such examples, the control surface management circuitry 132 can generate instructions to control surface(s) (e.g., ailerons) of the fourth freewing 114 (and/or the control surfaces of the other freewings 104, 108, 110) to control roll of the air vehicle 100.

FIG. 6 is a side view of the example fourth freewing 114 of FIGS. 1-5. In particular, illustrates rotation of the fourth freewing 114 about a pivot point 600 defined by the spar 306 of FIG. 5. Although FIG. 6 is discussed in connection with the fourth freewing 114, the first, second, and/or third freewings 104, 108, 110, 114 of FIGS. 1-4 can pivot in the same or substantially same manner as the fourth freewing 114.

The example fourth freewing 114 includes one or more aft control surfaces. For example, the fourth freewing 114 includes a flap 602 at the trailing edge 202 of the fourth freewing 114. The flap 602 can be deflected by a control surface actuator 604 (e.g., a servo-actuator) operatively coupled to the flap 602. The control surface actuator 604 is communicatively coupled to the control surface management circuitry 132 of the air vehicle 100.

Deflection of the flap 602 via the control surface actuator 604 affects the angle of attack of the fourth freewing 114 and, as a result, a lift coefficient of the fourth freewing 114. For instance, when the flap 602 is in a neutral position (i.e., neither extended nor lowered from a retracted position), the angle of attack associated with the fourth freewing 114 is low. When the flap 602 is actuated to a raised position as shown in FIG. 6, the angle of attack and, thus, lift on the fourth freewing 114 is increased.

The fourth freewing 114 pivots about the pivot point 600 as represented by line 606 in FIG. 6 to maintain the angle of attack as defined by the amount of deflection of the flap 602. In particular, the fourth freewing 114 automatically pivots about the pivot point 600 to maintain the equilibrium angle of attack defined by the position of the flap 602. If, during flight, the fourth freewing 114 pivots such that the angle of attack is less than the equilibrium angle (e.g., a nose 608 of the fourth freewing 114 pivots downward), aerodynamic forces acting on the fourth freewing 114 push the nose 608 of the freewing 114 up to return the fourth freewing 114 to a position in which the angle of attack is at the equilibrium angle. If, during flight, the fourth freewing 114 pivots such that the angle of attack is greater than the equilibrium angle (e.g., the nose 608 of the fourth freewing 114 pivots upward), aerodynamic forces acting on the fourth freewing 114 push the nose 608 of the wing down to return the fourth freewing 114 to a position at which the angle of attack is at the equilibrium angle. When the angle of attack is at the equilibrium angle, the combination of aerodynamic and inertial forces produce a zero moment about the pivot point 600. Thus, in examples disclosed herein, the freewings 104, 108, 110, 114 automatically pivot to maintain the angle of attack without use of a control system (e.g., sensors) to control the respective positions of the freewings 104, 108, 110, 114.

For instance, during operation of the example air vehicle 100 in the hover mode shown in FIGS. 1 and 2, the flap 602 of the fourth freewing 114 (and the respective flaps of the other freewings 104, 108, 110, 114) can be in the neutral position (i.e., neither raised nor lowered from a retracted position). In some examples, the flap 602 remains in the neutral potion for at least some duration of time as the air vehicle transitions from the hover mode to forward flight. As the transition of the air vehicle 100 from the hover mode to forward flight progresses, the control surface actuator 604 can cause (e.g., based on instructions from the control surface management circuitry 132) the flap 602 to move or extend from the neutral position to the position shown in FIG. 6 to increase the angle of the attack of the fourth freewing 114 and, thus, provide lift for the air vehicle 100 in forward flight. The lift provided by freewings 104, 108, 110, 114 during forward flight reduces a load on the respective rotors 116, 118, 120, 122. In some examples, the control surface management circuitry 132 automatically generates instructions to control deflection of the flap 602 in response to commands (e.g., user inputs) for the air vehicle 100 to transition from vertical flight or hovering to forward flight. During forward flight, the control surface actuator 604 can control deflection of the flap 602 based on instructions from the control surface management circuitry 132.

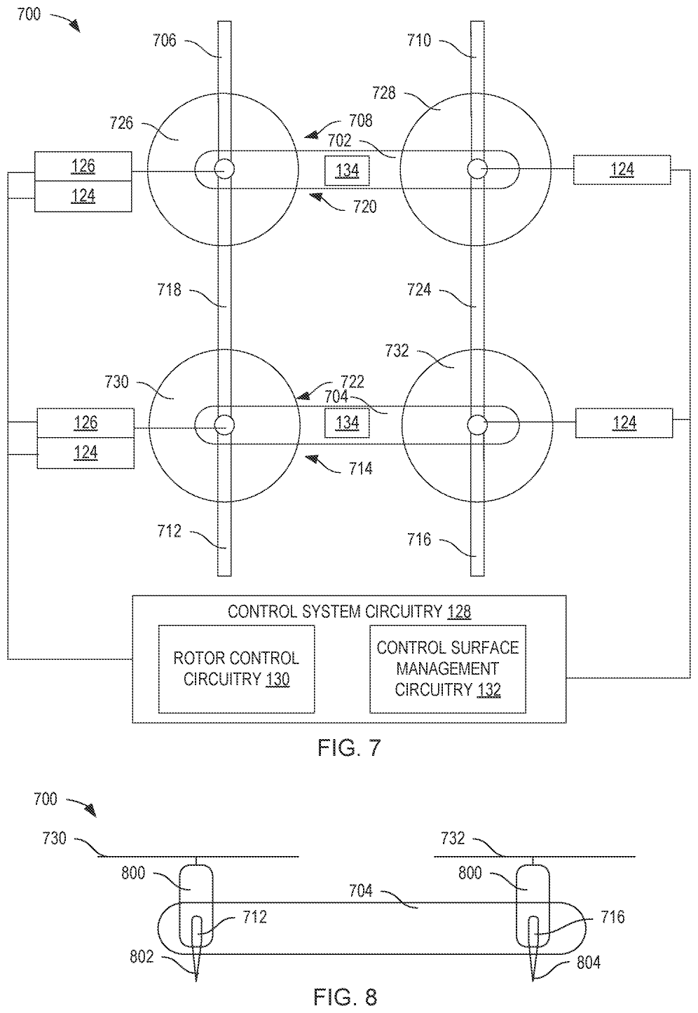

FIG. 7 illustrates a second example air vehicle 700 in accordance with teachings of this disclosure. In particular, FIG. 7 shows a top view of the air vehicle 700 when the air vehicle 700 is in a first flight mode corresponding to the hover mode.

The example air vehicle 700 of FIG. 7 includes a first fuselage 702 and a second fuselage 704. Thus, as compared to the first example air vehicle 100 of FIGS. 1-4 that includes the central fuselage 102, in the example of FIG. 7, the central fuselage has been replaced with two fuselages 702, 704.

In the example of FIG. 7, a first freewing 706 and a second freewing 710 are pivotably coupled to a first side 708 of the first fuselage 702. A third freewing 712 and a fourth freewing 716 are pivotably coupled to a first side 714 of the second fuselage 704. As shown in FIG. 7, the first, second, third, and fourth freewings 706, 710, 712, 716 define outboard wings of the air vehicle 700.

The air vehicle 700 of FIG. 7 includes a fifth freewing 718 pivotably coupled to a second side 720 of the first fuselage 702 and a second side 722 of the second fuselage 704. The example air vehicle 700 of FIG. 7 includes a sixth freewing 724 pivotably coupled to the second side 720 of the first fuselage 702 and the second side 722 of the second fuselage 704. In the example of FIG. 7, the fifth freewing 718 and the sixth freewing 724 can pivot independently of the outboard freewings 706, 710, 712, 716. The freewings 706, 710, 712, 716, 718, 724 of the second example air vehicle 700 can be the same or substantially the same as freewings 104, 108, 110, 114 of the first example air vehicle 100 of FIGS. 1-6.

The freewings 706, 710, 712, 716, 718, 724 of the air vehicle 700 of FIG. 7 can be coupled to the fuselages 702, 704 in a different arrangement than shown in FIG. 7 and/or can have different shapes and/or sizes than shown in FIG. 7. The example air vehicle 700 can include additional or fewer freewings than shown in FIG. 7. Also, as disclosed herein, in some examples, the air vehicle 700 includes other components such as horizontal and/or vertical stabilizers, landing gear, etc.

In the example of FIG. 7, a first rotor 726 (e.g., a proprotor) is carried by the first fuselage 702 at a forward section of the first fuselage 702 and a second rotor 728 is carried by the first fuselage 702 at an aft section of the first fuselage 702. A third rotor 730 is carried by the second fuselage 704 at a forward section of the second fuselage 704 and a fourth rotor 732 is carried by the second fuselage 704 at an aft section of the second fuselage 704. The rotors 726, 728, 730, 732 can be coupled to the fuselages 702, 704 via respective mounts (FIG. 8). Each of the rotors 726, 728, 730, 732 includes two or more blades that rotate about a shaft operatively coupled to respective motors 124.

When the example air vehicle 700 is in the hover mode, the rotors 726, 728, 730, 732 are in the first rotor orientation in which each of the rotors 726, 728, 730, 732 rotates in a substantially horizontal plane of rotation. In the example of FIG. 7, the first rotor 726 is coupled to the first fuselage 702 such that first rotor 726 can tilt relative to the respective fuselage 702 between the first rotor orientation and the second rotor orientation in which the first rotor 726 rotates in a substantially vertical plane of rotation. Also, the third rotor 730 is coupled to the second fuselage such that the third rotor 730 can tilt relative to the second fuselage 704 between the first rotor orientation and the second rotor orientation. The first rotor 726 and the third rotor 730 are operatively coupled to the respective tilt actuators 126 to control tilting of the rotors 726, 730. The motors 124 and the tilt actuators 126 are operatively coupled to the rotor control circuitry 130 of the control system circuitry 128.

FIG. 8 is a side view of the second example air vehicle 700 of FIG. 7 in the hover mode. As shown in FIG. 8, the rotors 730, 732 are supported by respective mounts 800 coupled to the second fuselage 704. The downward forces or download generated as a result of operation of the rotors 726, 728, 730, 732 in the first rotor orientation causes the freewings 706, 710, 712, 716, 718, 724 to pivot such that the trailing edges of the freewings 706, 710, 712, 716, 718, 724 are oriented in a downward direction (e.g., toward a ground surface). As illustrated in FIG. 8, the third freewing 712 is rotated relative to the second fuselage 704 such that a trailing edge 802 of the third freewing 712 is oriented downward (e.g., in a direction of a ground surface). Similarly, the fourth freewing 716 is rotated relative to the second fuselage 704 such that a trailing edge 804 of the fourth freewing 716 is oriented downward in a direction of the ground surface.

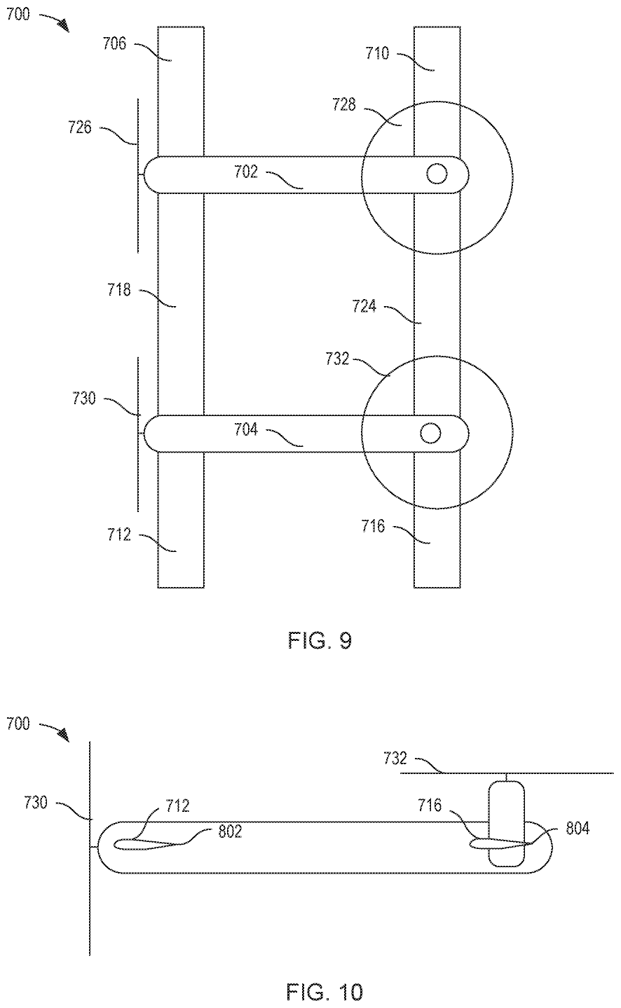

FIG. 9 is a top view of the example air vehicle 700 in a forward flight mode, or a mode in which the freewings 706, 710, 712, 716, 718, 724 produce lift during forward flight of the air vehicle 700. FIG. 10 is a side view of the example air vehicle 700 in the forward flight mode.

As disclosed in connection with the first example air vehicle 100 of FIGS. 1-4, the air vehicle 700 can transition from a vertical flight mode or the hover mode to the forward flight mode in response to, for instance, a command generated by the control system circuitry 128. As illustrated in FIG. 10, during the transition of the air vehicle 700 from the hover mode of FIGS. 7 and 8 to the forward flight mode of FIGS. 9 and 10, the freewings 712, 716 pivot such that the freewings 712, 716 are substantially aligned with the freestream or airflow over the freewings 712, 716 (e.g., the respective trailing edges 802, 804 are moved counterclockwise from the positions in FIG. 8). The freewings 706, 710, 712, 716, 718, 724 pivot to maintain an angle of attack as defined by deflection of control surface(s) of the freewings 706, 710, 712, 716, 718, 724 based on instructions from the control surface management circuitry 132 (FIG. 7).

In the example of FIGS. 9 and 10, the tilt actuator 126 associated with the first rotor 726 causes (in response to instructions from the rotor control circuitry 130) the first rotor 726 to pivot relative to the first fuselage 702 to move from the first rotor orientation to the second rotor orientation. As a result, the first rotor 726 rotates in a substantially vertical plane of rotation in the second rotor orientation. Also, the tilt actuator 126 associated with the third rotor 730 causes the third rotor 730 to pivot relative to the second fuselage 704 to move from the first rotor orientation of FIG. 7 to the second rotor orientation, as shown in FIG. 10.

When the example air vehicle 700 of FIGS. 7-10 is in the forward flight mode, the rotor control circuitry 130 can generate instructions to cause the second rotor 728 and the fourth rotor 732 (i.e., the aft rotors) to cease operating during forward flight. In the example of FIGS. 7-10, the aft rotors 728, 730 rotate with the first and third rotors 726, 730 (i.e., the forward rotors) to generate sufficient thrust for vertical flight. However, during forward flight, stopping operation of the second and fourth rotors 728, 732 does not limit flight speed. Thus, operation of the second and fourth rotors 728, 732 can be stopped during forward flight of the second air vehicle 700 without adversely affecting performance of the second air vehicle 700.

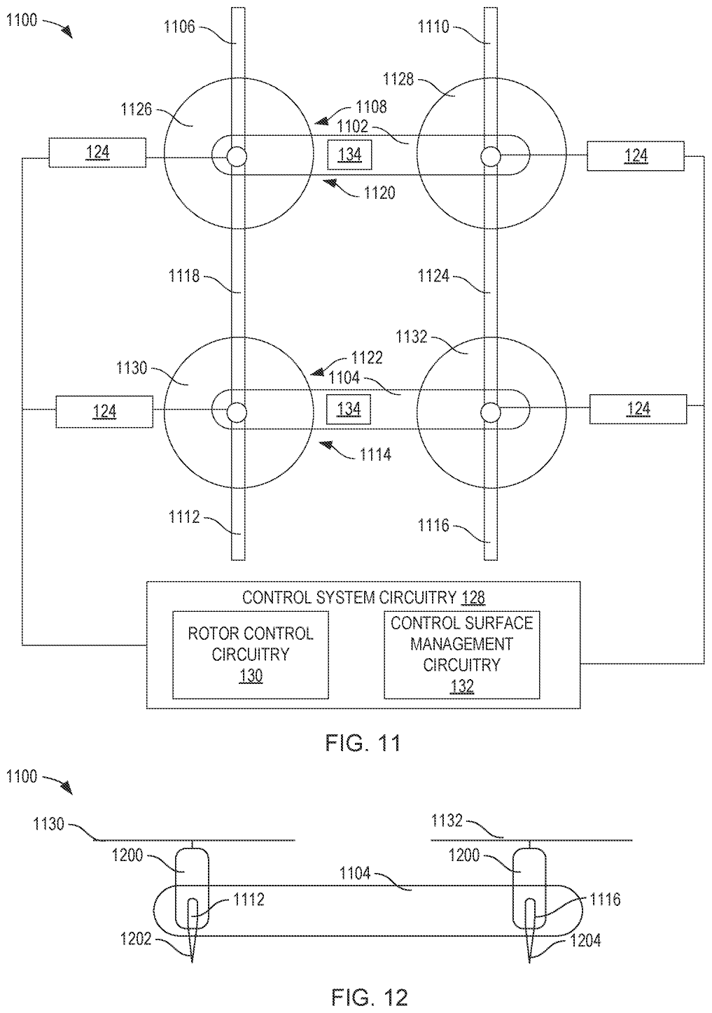

FIG. 11 illustrates a third example air vehicle 1100 in accordance with teachings of this disclosure. In particular, FIG. 11 shows a top view of the air vehicle 1100 when the air vehicle 1100 is in a first flight mode corresponding to a hover mode.

The example air vehicle 1100 of FIG. 11 includes a first fuselage 1102 and a second fuselage 1104. However, in other examples, the air vehicle 1100 of FIG. 11 includes one fuselage (i.e., a central fuselage as shown in FIG. 1).

In the example of FIG. 11, a first freewing 1106 and a second freewing 1110 are pivotably coupled to a first side 1108 of the first fuselage 1102. The air vehicle 1100 includes a third freewing 1112 and a fourth freewing 1116 pivotably coupled to a first side 1114 of the second fuselage 1104. The air vehicle 1100 of FIG. 11 includes a fifth freewing 1118 pivotably coupled to a second side 1120 of the first fuselage 1102 and a second side 1122 of the second fuselage 1104. The example air vehicle 1100 of FIG. 11 includes a sixth freewing 1124 pivotably coupled to the second side 1120 of the first fuselage 1102 and the second side 1122 of the second fuselage 1104. In the example of FIG. 11, each of the freewings 1106, 1110, 1112, 1116, 1118, 1124 is independent pivotably relative to the corresponding fuselages 1102, 1104.

The freewings 1106, 1110, 1112, 1116, 1118, 1124 of the air vehicle 1100 of FIG. 11 can be coupled to the fuselages 1102, 1104 in a different arrangement than shown in FIG. 11 and/or can have different shapes and/or sizes than shown in FIG. 11. The example air vehicle 1100 can include additional or fewer freewings than shown in FIG. 11. Also, as disclosed herein, in some examples, the air vehicle 1100 includes additional components such as horizontal and/or vertical stabilizers, landing gear, etc.

In the example of FIG. 11, a first rotor 1126 (e.g., a proprotor) is carried by the first fuselage 1102 at a forward section of the first fuselage 1102 and a second rotor 1128 is carried by the first fuselage 1102 at an aft section of the first fuselage 1102. A third rotor 1130 is carried by the second fuselage 1104 at a forward section of the second fuselage 1104 and a fourth rotor 1132 is carried by the second fuselage 1104 at an aft section of the second fuselage 1104. The rotors 1126, 1128, 1130, 1132 can be coupled to the fuselages 1102, 1104 via respective mounts (FIG. 12). Each of the rotors 1126, 1128, 1130, 1132 includes two or more blades that rotate about a shaft that is operatively coupled to respective motors 124. Operation of the motors 124 and, thus, the rotors 1126, 1128, 1130, 1132 can be controlled by the rotor control circuitry 130.

When the example air vehicle 1100 is in the hover mode, the rotors 1126, 1128, 1130, 1132 are in the first rotor orientation in which each of the rotors 1126, 1128, 1130, 1132 rotates in a substantially horizontal plane of rotation. In the example of FIG. 11, the rotors 1126, 1128, 1130, 1132 are fixed relative to the corresponding fuselages 1102, 1104. Thus, as compared to the example air vehicles 100, 700 of FIGS. 1 and 7, the example air vehicle 1100 of FIG. 1 does not include the tilt actuator 126 to cause one or more of the rotors 1126, 1128, 1130, 1132 to tilt.

FIG. 12 is a side view of the third example air vehicle 1100 of FIG. 11 in the hover mode. As shown in FIG. 12, the rotors 1130, 1132 are supported by respective mounts 1200 coupled to the second fuselage 1104. The downward forces or download generated as a result of operation of the rotors 1126, 1128, 1130, 1132 in the first rotor orientation causes the freewings 1106, 1110, 1112, 1116, 1118, 1124 to pivot such that the trailing edges of the freewings 1106, 1110, 1112, 1116, 1118, 1124 are moved in a downward direction (e.g., toward a ground surface). As illustrated in FIG. 12, the third freewing 1112 is rotated relative to the second fuselage 1104 such that a trailing edge 1202 of the third freewing 1112 is oriented downward (i.e., in a direction of a ground surface). Similarly, the fourth freewing 1116 is rotated relative to the second fuselage 1104 such that a trailing edge 1204 of the fourth freewing 1116 is oriented downward toward the ground surface.

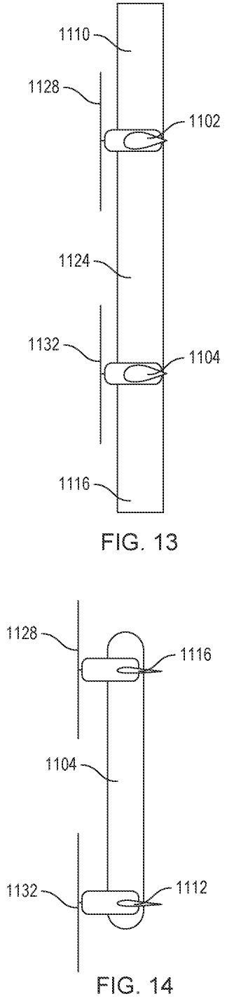

FIG. 13 is a top view of the example air vehicle 1100 in the forward flight mode, or a mode in which the freewings 1106, 1110, 1112, 1116, 1118, 1124 produce lift during forward flight of the air vehicle 700. FIG. 14 is a side view of the example air vehicle 1100 in the forward flight mode.

As disclosed in connection with FIG. 11, the first and second rotors 1126, 1128 are fixed relative to the first fuselage 1102 and the third and fourth rotors 1130, 1132 are fixed relative to the second fuselage 1104. To transition from a vertical flight mode or hover mode to a forward flight mode, the example air vehicle 1100 of FIGS. 11-13 tilts forward approximately 90 degrees as shown in FIG. 13.

To tilt the example air vehicle 1100 from the vertical flight mode (e.g., the hover mode) shown in FIGS. 11 and 12 to the forward flight mode shown in FIGS. 13 and 14, the thrust balance between the forward rotors 1126, 1130 and the aft rotors 1128, 1132 is varied based on instructions from the rotor control circuitry 130. For example, to adjust a pitch angle of the air vehicle 1100 to facilitate forward flight, the thrust generated by the aft rotors 1128, 1132 is increased relative to the thrust generated by the forward rotors 1126, 1130. The increased thrust of the aft rotors 1128, 1132 causes the air vehicle 1100 to pitch forward from the orientation of the air vehicle 1100 shown in FIGS. 11 and 12. Also, as a result of the increased thrust of the aft rotors 1128, 1132, a direction of the thrust associated with the respective rotors 1126, 1130, 1128, 1132 also changes. In particular, the direction of the rotor thrust also tilts forward in the direction of movement of the air vehicle 1100, which increases a speed of air vehicle 1100.

During the transition of the air vehicle 1100 from vertical fight to forward flight, the freewings 1106, 1110, 1112, 1116, 1118, 1124 pivot (i.e., automatically pivot) relative to the respective fuselages 1102, 1104 to produce lift. In particular, the freewings 1106, 1110, 1112, 1116, 1118, 1124 pivot to maintain an angle of attack during forward flight. The angle of attack can be defined by actuation of control surface(s) (e.g., flap(s)) of the freewings 1106, 1110, 1112, 1116, 1118, 1124, as controlled by the control surface management circuitry 132 (FIG. 11)

As shown in FIG. 14, the freewings 1112, 1116 rotate such that the trailing edges 1202, 1204 of the freewings 1112, 1116 are moved in a counterclockwise direction relative to the position of the trailing edges 1202, 1204 shown in FIG. 12. During forward flight of the air vehicle 1100, the freewings 1106, 1110, 1112, 1116, 1118, 1124 produce lift to maintain flight and the rotors 1126, 1130, 1128, 1132 generate thrust.

FIG. 15 is a top view of a fourth example air vehicle 1500. FIG. 16 is a side view of the fourth example air vehicle 1500. The fourth example air vehicle 1500 can correspond to, for example, the first example air vehicle 100 of FIGS. 1-6. For instance, the fourth example air vehicle 1500 includes a fuselage 1502 and first through fourth freewings 1504, 1506, 1508, 1510 pivotably coupled to the fuselage 1502. The first through fourth freewings 1504, 1506, 1508, 1510 carry respective rotors 1512, 1514, 1516, 1518. For illustrative purposes, the fourth example air vehicle 1500 is shown in the forward flight mode.

The fourth example air vehicle 1500 includes horizontal stabilizers 1520, 1522 coupled to the fuselage 1502. Also, as shown in FIG. 16, the fourth example air vehicle 1500 includes a vertical stabilizer 1600 coupled to the fuselage 1502. The horizontal stabilizer(s) 1520, 1522 and the vertical stabilizer 1600 can facilitate stability of the air vehicle 1500 during, for example, forward flight of the air vehicle 1500. For instance, the vertical stabilizer 1600 can provide means for controlling yaw of the air vehicle 1500 to help stabilize the aircraft in view of the pivoting of the freewings 1504, 1506, 1508, 1510 during flight.

Although the fourth example air vehicle 1500 is discussed in connection with the first example air vehicle 100 of FIGS. 1-6, the second air vehicle 700 of FIGS. 7-10 and/or the third example air vehicle 1100 of FIGS. 11-14 can include the horizontal stabilizer(s) 1520 and/or the vertical stabilizer(s) 1600.

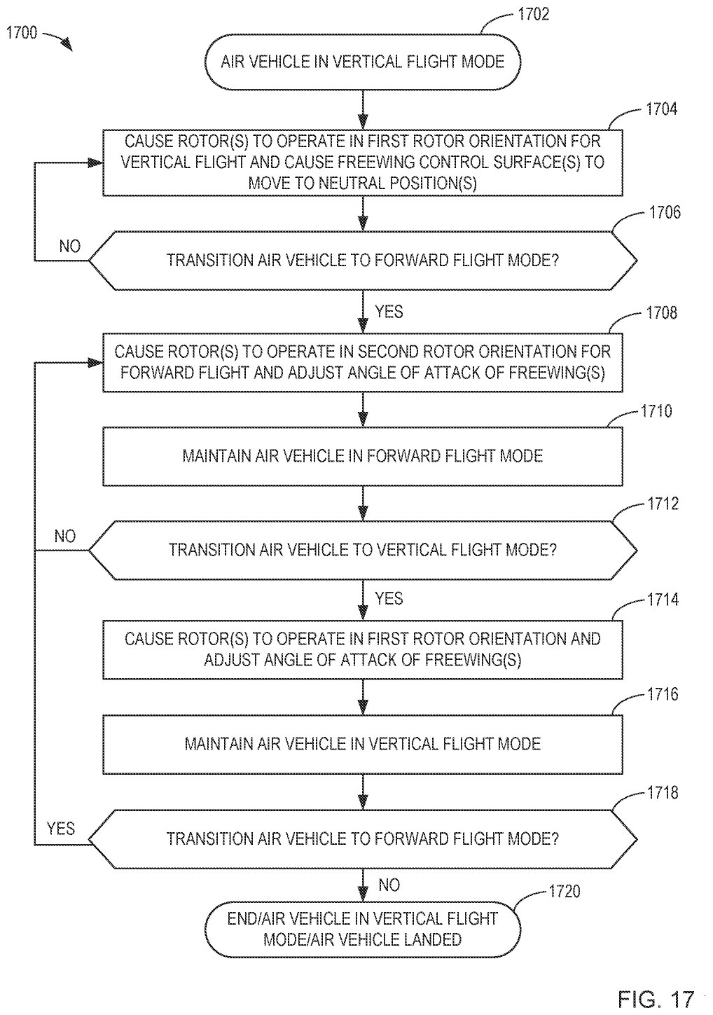

FIG. 17 is a flowchart representative of example machine readable instructions and/or example operations 1700 that may be executed by example processor circuitry to control transition(s) of the example first, second, and/or third air vehicles 100, 700, 1100 between flight modes.

The example instructions 1700 begin at block 1702 when the first, second, and/or third air vehicles 100, 700, 1100 are in a vertical flight mode, such as a vertical takeoff or hovering. At block 1704, to maintain the air vehicle 100, 700, 1100 in the vertical flight mode, the rotor control circuitry 130 of the example control system circuitry 128 of FIGS. 1, 7, and 11 causes the rotors 116, 118, 120, 122 of the first air vehicle 100, the rotors 726, 728, 730, 732 of the second air vehicle 700, and/or the rotors 1126, 1128, 1130, 1132 of the third air vehicle 1100 to operate in a first rotor orientation for vertical flight and/or hovering by the air vehicle 100, 700, 1100. In the first rotor orientation, the rotors 116, 118, 120, 122, 726, 728, 730, 732, 1126, 1128, 1130, 1132 rotate in a substantially horizontal plane of rotation to produce thrust and lift for vertical takeoff and hovering. Also, the rotor control circuitry 130 controls a speed of the motor(s) 124 to cause a combined thrust of the rotors (e.g., the rotors 116, 118, 120, 122 of the first air vehicle 100) to provide lift (i.e., sufficient lift) for the air vehicle 100, 700, 1100 to operate in the vertical flight mode. The rotor control circuitry 130 uses differential thrust between the forward rotors (e.g., the rotors 116, 120 of the first air vehicle 100) and the rear rotors (e.g., the rotors 118, 122 of the first air vehicle 100) to maintain fore-aft balance. The rotor control circuitry 130 uses differential thrust between the left rotors (e.g., the rotors 120, 122) and the right rotors (e.g., the rotors 116, 118) to maintain side-to-side balance of the air vehicle 100, 700, 1100.

Also, at block 1704, the control surface management circuitry 132 of the control system circuitry 128 instructs the control surface actuator(s) 604 to move (or maintain) the freewing control surface(s) 602 (e.g., flap(s)) to a neutral position to enable the freewings (e.g., the freewings 104, 108, 110, 114 of the first air vehicle 100) to rotate to a position in which the trailing edge of the freewings (e.g., the freewings 104, 108, 110, 114 of the first air vehicle 100) is in a down position (e.g., as shown in FIG. 2) to minimize download from the rotors (e.g., the 116, 118, 120, 122) on the freewings (e.g., the freewings 104, 108, 110, 114).

At block 1706, a determination is made if the air vehicle 100, 700, 1100 should transition to a forward flight mode. In the example of FIG. 17, the air vehicle 100, 700, 1100 can transition to the forward flight mode in response to user input(s) received by the control system circuitry 128.

To transition the air vehicle 100, 700, 1100 from the vertical flight mode to the forward flight mode, at block 1708, the rotor control circuitry 130 instructs the tilt actuator(s) 126 to cause the rotors 116, 118, 120, 122, 726, 730, to move from the first rotor orientation in which the rotors 116, 118, 120, 122, 726, 730 rotate in a horizontal plane to a second rotor orientation in which the rotors 116, 118, 120, 122, 726, 730 rotate in a vertical plane (i.e., the second rotor orientation) to produce thrust during forward flight of the air vehicle 100, 700, 1100. In such examples, lift is provided by the freewings 104, 108, 110, 114, 706, 710, 712, 716, 718, 724, 1106, 1110, 1112, 1116, 1118, 1124 of the respective air vehicles 100, 700, 1100.

In some examples of block 1708, the rotor control circuitry 130 causes the tilt actuators 126 to cause the rotors 116, 118, 120, 122 of the first air vehicle 100 of FIGS. 1-6 to tilt relative to respective freewings 104, 108, 110, 114 to move to the second rotor orientation. In some examples, the rotor control circuitry 130 causes the tilt actuators 126 to cause the forward rotors 726, 730 of the second air vehicle 700 of FIGS. 7-10 to tilt relative to the respective fuselages 702, 704 to move to the second rotor orientation. In such examples, the rotor control circuitry 130 can instruct the aft rotors 728, 732 to stop rotating during forward flight. In some examples, the rotor control circuitry 130 causes an amount of thrust generated by the rotors 1126, 1128, 1130, 1132 of the third air vehicle 1100 to increase to adjust a pitch of the air vehicle 1100 (e.g., to cause the air vehicle 1100 to pitch forward) such that the rotors 1126, 1128, 1130, 1132 operate in the second rotor orientation.

Also, at block 1708, the rotor control circuitry 130 controls a speed of the rotor motor(s) 124 so that a combined thrust of the rotors (e.g., the rotors 116, 118, 120, 122 of the first air vehicle 100) in concert with the freewings (e.g., the freewings 104, 108, 110, 114 of the first air vehicle 100) provides lift (i.e., sufficient lift) for the air vehicle 100, 700, 1100 to accelerate forward to increase speed. During the vertical flight mode and at low forward speeds, the rotor control circuitry 130 uses differential thrust between the forward rotors (e.g., the rotors 116, 120 of the first air vehicle 100) and the rear rotors (e.g., the rotors 118, 122 of the first air vehicle 100) to maintain fore-aft balance of the air vehicle 100, 700, 1100. The rotor control circuitry 130 also uses differential thrust between the left rotors (e.g., the rotors 120, 122 of the first air vehicle 100) and the right rotors (e.g., the rotors 116, 118 of the first air vehicle 100) to maintain side-to-side balance of the air vehicle. As the forward speed of the air vehicle 100, 700, 1100 increases, the rotor control circuitry 130 phases out use of the differential thrust to maintain balance of the air vehicle 100, 700, 1100 and instead, uses the combined thrust of the rotors (e.g., the rotors 116, 118, 120, 122 of the first air vehicle 100) and the freewings (e.g., the freewings 104, 108, 110, 114 of the first air vehicle 100) to maintain the air vehicle 100, 700, 1100 in forward flight mode (block 1710).

Also, at blocks 1708 and 1710, as forward speed of the air vehicle 100, 700, 1100 increases, the control surface management circuitry 132 instructs the control surface actuator(s) 604 to move the freewing control surface(s) 602 to adjust the angle of attack and, thus, lift provided by the freewings 104, 108, 110, 114, 706, 710, 712, 716, 718, 724, 1106, 1110, 1112, 1116, 1118, 1124. For instance, the control surface management circuitry 132 can generate instruction(s) to cause the control surface actuator(s) 604 to move the freewing control surface(s) 602 from a neutral position to an extended position (e.g., as represented in FIG. 6) to increase the angle of attack and, as a result, increase lift provided by the freewings 104, 108, 110, 114, 706, 710, 712, 716, 718, 724, 1106, 1110, 1112, 1116, 1118, 1124. In particular, the control surface management circuitry 132 adjusts the freewing angle of attack such that the combined lift of the freewings (e.g., the freewings 104, 108, 110, 114 of the first air vehicle 100 of the first air vehicle 100) in concert with the rotors (e.g., the rotors 116, 118, 120, 122 of the first air vehicle 100) offsets a weight of the air vehicle 100, 700, 1100. As the forward speed of air vehicle 100, 700, 1100 increases, the control surface management circuitry 132 adjusts differential lift between the forward freewings (e.g., the freewings 104, 110 of the first air vehicle 100) and the rear freewings (e.g., the freewings 108, 114 of the first air vehicle 100) to maintain fore-aft balance of the air vehicle 100, 700, 1100. Also, the control surface management circuitry 132 controls differential lift between the left freewings (e.g., the freewings 110, 114 of the first air vehicle 100) and the right freewings (e.g., the freewings 104, 108 of the first air vehicle 100) to maintain side-to-side balance of the air vehicle 100, 700, 1100 and to initiate turns.

At block 1712, a determination is made if the air vehicle 100, 700, 1100 should transition to the vertical flight mode from the forward flight mode. In the example of FIG. 17, the air vehicle 100, 700, 1100 can transition to the vertical flight mode the forward flight mode in response to user input(s) received by the control system circuitry 128 to enable, for instance, vertical landing of the air vehicle 100, 700, 1100.

At block 1714, the rotor control circuitry 130 instructs the tilt actuator(s) 126 to cause the rotors 116, 118, 120, 122, 726, 730 to move from the second rotor orientation in which the rotors 116, 118, 120, 122, 726, 730 rotate in a vertical plane to the first rotor orientation in which the rotors 116, 118, 120, 122, 726, 730 rotate in a horizontal plane.

Also, at block 1714, the rotor control circuitry 130 controls a speed of the rotor motor(s) 124 so that the combined thrust of the rotors (e.g., the rotors 116, 118, 120, 122 of the first air vehicle 100) is sufficient to propel the air vehicle 100, 700, 1100 but to cause the air vehicle 100, 700, 1100 to decelerate from forward flight speeds to vertical flight. As the forward flight speed decreases, the rotor control circuitry 130 uses differential thrust such that the rotors (e.g., the rotors 116, 118, 120, 122 of the first air vehicle 100) assist the freewings (e.g., the freewings 104, 108, 110, 114 of the first air vehicle 100) in maintaining the balance of the air vehicle 100, 700, 1100 as an effectiveness of the freewings (e.g., the freewings 104, 108, 110, 114 of the first air vehicle 100) in maintaining balance of the air vehicle 100, 700, 1100 is reduced at low speeds. The rotor control circuitry 130 uses differential thrust between the forward rotors (e.g., the rotors 116, 120 of the first air vehicle 100) and the rear rotors (e.g., the rotors 118, 122 of the first air vehicle 100) to maintain fore-aft balance and uses differential thrust between the left rotors (e.g., the rotors 120, 122 of the first air vehicle 100) and the right rotors (e.g., the rotors 116, 118 of the first air vehicle 100) to maintain side-to-side balance.

Also, at block 1714, as forward speed of the air vehicle 100, 700, 1100 decreases during the transition to vertical flight, the control surface management circuitry 132 instructs the control surface actuator(s) 604 to move the control surface(s) 602 to the neutral position to enable the freewings (e.g. the freewings 104, 108, 110, 114 of the first air vehicle 100) freely rotate to a position in which the trailing edge of the freewings (e.g. the freewings 104, 108, 110, 114) is down (e.g., as shown in FIG. 2) to minimize download from the rotors (e.g., the rotors 116, 118, 120, 122 of the first air vehicle 100) on the freewings (e.g. e.g., the freewings 104, 108, 110, 114).

The control system circuitry 128 (e.g., the rotor control circuitry 130, the control surface management circuitry 132) maintains the air vehicle 100, 700, 1100 in the vertical flight mode if and until a decision (e.g., via a user input) is received to transition the air vehicle to the forward flight mode (block 1718). The example instructions 1700 of FIG. 17 end at block 1720 when the air vehicle 100, 700, 1100 has for instance, landed.

While an example manner of the control system circuitry 128 is illustrated in FIGS. 1, 7, and 11, one or more of the elements, processes, and/or devices illustrated in FIGS. 1, 7, and 11 may be combined, divided, re-arranged, omitted, eliminated, and/or implemented in any other way. Further, the example rotor control circuitry 130, the example control surface management circuitry 132, and/or, more generally, the example control system circuitry 128 of FIGS. 1, 7, and 11, may be implemented by hardware alone or by hardware in combination with software and/or firmware. Thus, for example, any of the example rotor control circuitry 130, the example control surface management circuitry 132, and/or, more generally, the example control system circuitry 128, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example control system circuitry 128 of FIGS. 1, 7, and/or 11 may include one or more elements, processes, and/or devices in addition to, or instead of, those illustrated in FIGS. 1, 7, and 11, and/or may include more than one of any or all of the illustrated elements, processes, and devices.

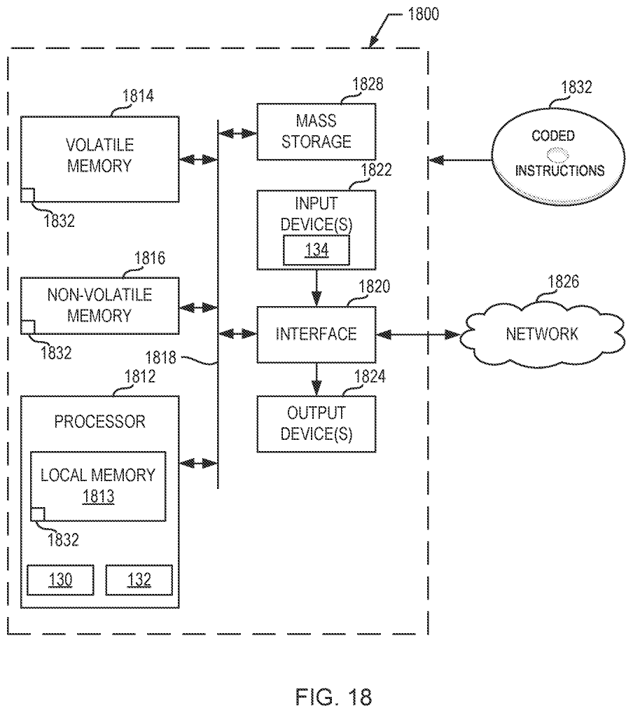

The flowchart of FIG. 17 is representative of example hardware logic circuitry, machine readable instructions, hardware implemented state machines, and/or any combination thereof for implementing the control system circuitry 128 of FIGS. 1, 7, and 11. The machine readable instructions may be one or more executable programs or portion(s) of an executable program for execution by processor circuitry, such as the processor circuitry 1812 shown in the example processor platform 1800 discussed below in connection with FIG. 18. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 17, many other methods of implementing the example control system circuitry 128 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 17 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 18 is a block diagram of an example processor platform 1800 structured to execute and/or instantiate the machine readable instructions and/or the operations of FIG. 17 to implement the control system circuitry 128 of FIGS. 1, 7, and/or 11. The processor platform 1800 can be, for example, a server, a personal computer, a workstation, a mobile device (e.g., a cell phone, a smart phone, a tablet such as an iPad′), a personal digital assistant (PDA), an Internet appliance, or any other type of computing device.

The processor platform 1800 of the illustrated example includes processor circuitry 1812. The processor circuitry 1812 of the illustrated example is hardware. For example, the processor circuitry 1812 can be implemented by one or more integrated circuits, logic circuits, FPGAs, microprocessors, CPUs, GPUs, DSPs, and/or microcontrollers from any desired family or manufacturer. The processor circuitry 1812 may be implemented by one or more semiconductor based (e.g., silicon based) devices. In this example, the processor circuitry 1812 implements the example rotor control circuitry 130 and the example control surface management circuitry 132.

The processor circuitry 1812 of the illustrated example includes a local memory 1813 (e.g., a cache, registers, etc.). The processor circuitry 1812 of the illustrated example is in communication with a main memory including a volatile memory 1814 and a non-volatile memory 1816 by a bus 1818. The volatile memory 1814 may be implemented by Synchronous Dynamic Random Access Memory (SDRAM), Dynamic Random Access Memory (DRAM), RAIVIBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817.

The processor platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1822 are connected to the interface circuitry 1820. In the example of FIG. 18, the input device(s) 1822 can include the sensor(s) 134 of the air vehicle(s) 100, 700, 1100 to provide signals for analysis by the control system circuitry 128. The input device(s) 1822 can permit a user to enter data and/or commands into the processor circuitry 1812. The input device(s) 1822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1824 are also connected to the interface circuitry 1820 of the illustrated example. The output device(s) 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1800 of the illustrated example also includes one or more mass storage devices 1828 to store software and/or data. Examples of such mass storage devices 1828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1832, which may be implemented by the machine readable instructions of FIG. 17, may be stored in the mass storage device 1828, in the volatile memory 1814, in the non-volatile memory 1816, and/or on a removable non-transitory computer readable storage medium such as a CD or DVD.

From the foregoing, it will be appreciated that example systems, methods, apparatus, and articles of manufacture have been disclosed that provide for efficient transition of an air vehicle between vertical flight and forward flight modes. Example air vehicles disclosed herein include freewings that automatically pivot to maintain an angle of attack of the wing. In some examples, the freewings carry rotors, where the rotors can be pivoted independently of the freewings to change a plane of rotation of the rotors during the transition between flight modes. In disclosed examples, the freewings can automatically pivot when the air vehicle operates in the hover mode to reduce forces exerted on the freewings due to airflow generated by the rotors. As a result, disclosed examples provide for efficient operation of the air vehicle in the hover mode as compared to vehicles with fixed wings. Disclosed examples provide for efficient transition of the air vehicle between flight modes due to the automatic pivoting of the freewings to generate lift for forward flight.

Example air vehicles including freewings and related methods are disclosed herein. Further examples and combinations thereof include the following:

Example 1 includes an air vehicle including a fuselage; a freewing coupled to the fuselage, the freewing pivotable relative to the fuselage; and a rotor carried by the freewing, the rotor pivotable independently of the freewing.

Example 2 includes the air vehicle of example 1, further including an actuator to cause the rotor to move from a first rotor orientation to a second rotor orientation during flight.

Example 3 includes the air vehicle of examples 1 or 2, wherein the first rotor orientation is associated with a hover mode of the air vehicle and the second rotor orientation is associated with a forward flight mode of the air vehicle.

Example 4 includes the air vehicle of any of examples 1-3, wherein the rotor is opposite a trailing edge of the freewing when the rotor is in the first rotor orientation or the second rotor orientation.

Example 5 includes the air vehicle of any of examples 1-4, wherein the freewing is a first freewing and the rotor is a first rotor and further including a second freewing and a second rotor carried by the second freewing.

Example 6 includes the air vehicle of any of examples 1-5, wherein the air vehicle is a quadcopter.

Example 7 includes the air vehicle of any of examples 1-6, wherein a trailing edge of the freewing includes a control surface, and further including an actuator to adjust the control surface to control an angle of attack associated with the freewing.

Example 8 include an air vehicle including a fuselage; a first freewing pivotably coupled to the fuselage; a second freewing pivotably coupled to the fuselage and spaced apart from the first freewing; a first rotor; and an actuator to cause the first rotor to tilt to change an orientation of the first rotor relative to the fuselage during flight.

Example 9 includes the air vehicle of example 8, wherein the actuator is to cause the first rotor to tilt from a vertical fight orientation to a forward flight orientation.

Example 10 includes the air vehicle of examples 8 or 9, further including a second rotor, the second rotor to be disposed in the forward flight orientation when the first rotor is in the forward flight orientation.

Example 11 includes the air vehicle of any of examples 8-10, further including a second rotor, the second rotor to be disposed in the vertical flight orientation when the first rotor is in the forward flight orientation.

Example 12 includes the air vehicle of any of examples 8-11, wherein the fuselage includes a first fuselage and a second fuselage, the first freewing pivotably coupled to the first fuselage and the second freewing pivotably coupled to the second fuselage.

Example 13 includes the air vehicle of any of examples 8-12, further including a third freewing disposed between the first fuselage and the second fuselage.

Example 14 includes the air vehicle of any of examples 8-13, wherein the actuator is first actuator, the first freewing includes a flap, and further including a second actuator operatively coupled to the flap.

Example 15 includes a method including causing a first rotor coupled to a first freewing of an aircraft to operate in a first orientation relative to a fuselage of the aircraft, the aircraft to operate in a hover mode when the first rotor is in the first orientation; and causing the first rotor to move from the first orientation to a second orientation relative to the fuselage during flight of the aircraft, the aircraft to operate in a forward flight mode when the first rotor is in the second orientation.

Example 16 includes the method of example 15, wherein causing the first rotor to move from the first orientation to the second orientation includes causing the first rotor to tilt.

Example 17 includes the method of examples 15 or 16, further including adjusting an angle of a control surface of the freewing when the aircraft is in the forward flight mode.

Example 18 includes the method of any of examples 15-17, wherein adjusting the angle of the control surface includes causing the control surface to deflect to an extended position.

Example 19 includes the method of any of examples 15-18, further including causing the control surface of the freewing to be in a neutral position during a transition from the hover mode to the forward flight mode.

Example 20 includes the method of any of examples 15-19, further including causing a second rotor coupled to a second freewing of the aircraft to move from the first orientation to the second orientation, each of the first rotor and the second rotor to be disposed in the second orientation.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An air vehicle comprising:
a fuselage;
a freewing coupled to the fuselage, the freewing pivotable relative to the fuselage; and
a rotor carried by the freewing, the rotor pivotable independently of the freewing.

2. The air vehicle of claim 1, further including an actuator to cause the rotor to move from a first rotor orientation to a second rotor orientation during flight.

3. The air vehicle of claim 2, wherein the first rotor orientation is associated with a hover mode of the air vehicle and the second rotor orientation is associated with a forward flight mode of the air vehicle.

4. The air vehicle of claim 2, wherein the rotor is opposite a trailing edge of the freewing when the rotor is in the first rotor orientation or the second rotor orientation.

5. The air vehicle of claim 1, wherein the freewing is a first freewing and the rotor is a first rotor and further including:
a second freewing; and
a second rotor carried by the second freewing.

6. The air vehicle of claim 5, wherein the air vehicle is a quadcopter.

7. The air vehicle of claim 1, wherein a trailing edge of the freewing includes a control surface, and further including an actuator to adjust the control surface to control an angle of attack associated with the freewing.

8. An air vehicle comprising:
a fuselage;
a first freewing pivotably coupled to the fuselage;
a second freewing pivotably coupled to the fuselage and spaced apart from the first freewing;
a first rotor; and
an actuator to cause the first rotor to tilt to change an orientation of the first rotor relative to the fuselage during flight.

9. The air vehicle of claim 8, wherein the actuator is to cause the first rotor to tilt from a vertical fight orientation to a forward flight orientation.

10. The air vehicle of claim 9, further including a second rotor, the second rotor to be disposed in the forward flight orientation when the first rotor is in the forward flight orientation.

11. The air vehicle of claim 9, further including a second rotor, the second rotor to be disposed in the vertical flight orientation when the first rotor is in the forward flight orientation.

12. The air vehicle of claim 8, wherein the fuselage includes a first fuselage and a second fuselage, the first freewing pivotably coupled to the first fuselage and the second freewing pivotably coupled to the second fuselage.

13. The air vehicle of claim 12, further including a third freewing disposed between the first fuselage and the second fuselage.

14. The air vehicle of claim 8, wherein the actuator is first actuator, the first freewing includes a flap, and further including a second actuator operatively coupled to the flap.

15. A method comprising:
causing a first rotor coupled to a first freewing of an aircraft to operate in a first orientation relative to a fuselage of the aircraft, the aircraft to operate in a hover mode when the first rotor is in the first orientation; and
causing the first rotor to move from the first orientation to a second orientation relative to the fuselage during flight of the aircraft, the aircraft to operate in a forward flight mode when the first rotor is in the second orientation.

16. The method of claim 15, wherein causing the first rotor to move from the first orientation to the second orientation includes causing the first rotor to tilt.

17. The method of claim 15, further including adjusting an angle of a control surface of the freewing when the aircraft is in the forward flight mode.

18. The method of claim 17, wherein adjusting the angle of the control surface includes causing the control surface to deflect to an extended position.

19. The method of claim 17, further including causing the control surface of the freewing to be in a neutral position during a transition from the hover mode to the forward flight mode.

20. The method of claim 15, further including causing a second rotor coupled to a second freewing of the aircraft to move from the first orientation to the second orientation, each of the first rotor and the second rotor to be disposed in the second orientation.
